(19) United States
(12) Patent Application Publication
(10) Pub. No.: US 2015/0095974 A1
(43) Pub. Date: Apr. 2, 2015

(54) WIRELESS COMMUNICATION METHOD IN ESL (ELECTRONIC SHELF LABEL) SYSTEM

(71) Applicant: SAMSUNG ELECTRO-MECHANICS CO., LTD., Gyeonggi-Do (KR)

(72) Inventors: Chung Hee LEE, Suwon-si (KR); Dae Gil YOON, Seoul (KR)

(73) Assignee: SAMSUNG ELECTRO-MECHANICS CO., LTD., Gyeonggi-Do (KR)

(21) Appl. No.: 14/498,278

(22) Filed: Sep. 26, 2014

(30) Foreign Application Priority Data
Sep. 27, 2013 (KR) 10-2013-0115389

(51) Int. Cl. H04L 29/06; H04W 52/02

(52) U.S. Cl. CPC H04L 63/20; H04W 52/0209
USPC 726/1

(57) ABSTRACT

Embodiments of the invention provide a wireless communication method in an ESL system including selecting any rows and columns in a matrix table to input each value of the selected rows and columns and values of intersecting points of the rows and the columns to matrix security fields of a data frame, respectively, wirelessly transmitting the frame from a tag to a gateway or from the gateway to the tag, receiving the transmitted frame and using a matrix value written in the matrix security fields, respectively, to retrieve the values of the intersecting points; discriminating whether the values of the retrieved intersecting point are equal to the values of the intersecting points written in the matrix security field of the received frame, and when two values are equal to each other in the discrimination, determining a received frame as a normal frame and analyzing the remaining field of the frame.

### CROSS REFERENCE TO RELATED APPLICATION

This application claims the benefit of and priority under 35 U.S.C. §119 to Korean Patent Application No. KR 10-2013-0115389, entitled “WIRELESS COMMUNICATION METHOD IN ESL (ELECTRONIC SHELF LABEL) SYSTEM,” filed on Sep. 27, 2013, which is hereby incorporated by reference in its entirety into this application.

### BACKGROUND

1. Field of the Invention

Embodiments of the invention relate to a wireless communication method in an electronic shelf label (ESL) system, and more particularly, to a wireless communication method in an ESL system capable of solving a security problem in wireless communication and reducing a computation operation quantity of a tag.

2. Description of the Related Art

Today, a price update system called an ESL system has been built, for example, in a large-scale discount store. The ESL system does not rely on a traditional method of writing a price on paper but relies on a method of electronically displaying a price on a display screen.

The ESL system is configured to generally include a server, a sink, and a tag. The sink and the tag use a wireless communication technology called Zigbee to transmit and receive data (information) and may be vulnerable to security in terms of characteristics of wireless communication. Therefore, a security algorithm based on a method of encrypting data using an encryption key in a Zigbee protocol has been proposed. However, the encryption method requires a lot of computations to encrypt and decode data and therefore requires much power. The tag uses a battery and therefore there is a need to simplify a computation operation if possible to reduce power consumption.

### SUMMARY

Accordingly, embodiments of the invention have been made to provide a wireless communication method in an ESL system capable of solving a security problem in wireless communication and reducing a computation operation quantity of a tag to reduce power consumption of a battery, by applying a simple security algorithm of a matrix type.

According to at least one embodiment, there is provided a wireless communication method in an ESL system, including a) selecting any rows and columns in a matrix table to input each value of the selected rows and columns and values of intersecting points of the rows and the columns to matrix security fields of a data frame, respectively, b) wirelessly transmitting the frame from a tag to a gateway or from the gateway to the tag, c) receiving the transmitted frame by the gateway or the tag and using a matrix value written in the matrix security fields, respectively to retrieve the values of the intersecting points in the matrix table; d) discriminating whether the values of the retrieved intersecting point are equal to the values of the intersecting points written in the matrix security field of the received frame, and e) when two values are equal to each other in the discrimination, determining the received frame as a normal frame and analyzing the remaining field of the frame.

According to at least one embodiment, the step of d) discriminating further includes determining and discarding the received frame as an abnormal frame when the two values are not equal to each other.

According to at least one embodiment, each value of columns and rows selected in the step a) is each input to a 4 bit field of the data frame and the values of the intersecting points of the rows and the columns is input to a 8 bit field of the data frame.

According to at least one embodiment, the 4 bit field of the data frame to which each value of the rows and the columns is input and the 8 bit field of the data frame to which the values of the intersecting points of the rows and the columns are input is configured of the matrix security field of the data frame format.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a diagram schematically illustrating a configuration of an ESL system in which a wireless communication method in an ESL system according to an embodiment of the invention is adopted.

FIG. 2 is a diagram illustrating an example of a Zigbee data frame structure of a general network level in which a security technology is adopted according to an embodiment of the invention.

FIG. 3 is a flow chart illustrating an execution process of a wireless communication method in an ESL system according to an embodiment of the invention.

FIG. 4 is a diagram conceptually illustrating a security algorithm of a matrix type which is adopted in the method according to an embodiment of the invention.

FIG. 5 is a diagram illustrating a state in which each value of rows and columns and intersecting points thereof is each input to matrix security fields of a frame format according to an embodiment of the invention.

### DETAILED DESCRIPTION

Advantages and features of the invention and methods of accomplishing the same will be apparent by referring to embodiments described below in detail in connection with the accompanying drawings. However, the invention is not limited to the embodiments disclosed below and may be implemented in various different forms. The embodiments are provided only for completing the disclosure of the invention and for fully representing the scope of the invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. According to at least one embodiment, the dimensions of some of the elements in the figures may be exaggerated relative to other elements to help improve understanding of embodiments of the invention. Like reference numerals refer to like elements throughout the specification.

Hereinafter, various embodiments of the invention will be described in detail with reference to the accompanying drawings.

Hereinafter, an ESL system in which a method of an embodiment of the invention is adopted will first be described, prior to describing various embodiments of the invention.

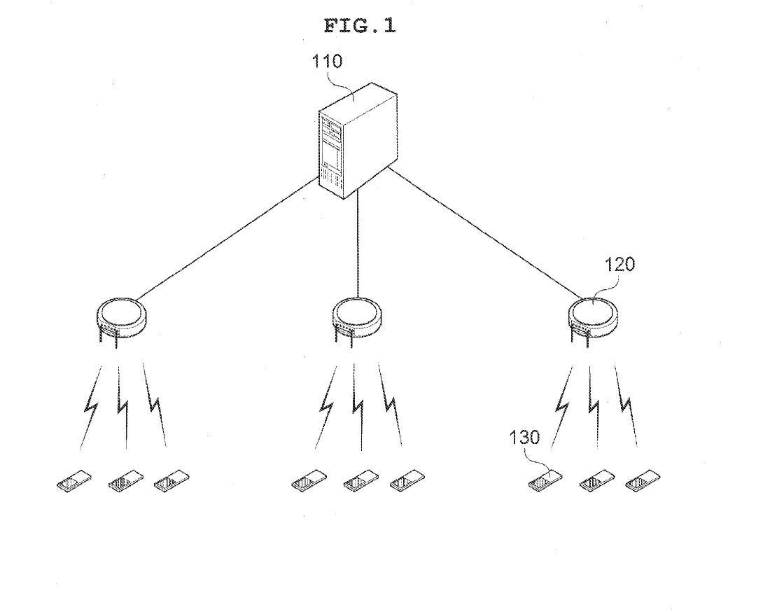

FIG. 1 is a diagram schematically illustrating a configuration of an ESL system in which a wireless communication method in an ESL system according to an embodiment of the invention is adopted.

Referring to FIG. 1, an ESL system is configured to include a server 110, a sink (gateway) 120, and a tag 130.

According to at least one embodiment, the server 110 has a price database. The sink (gateway) 120 serves to repeat between the server 110 and the tag 130. That is, the sink 120 serves to receive price formation (data) from the server 110 and transfer the received price information to each tag 130. The tag 130 receives the price information (data) from the sink (gateway) 120 and displays the price information on a display screen (for example, LCD screen).

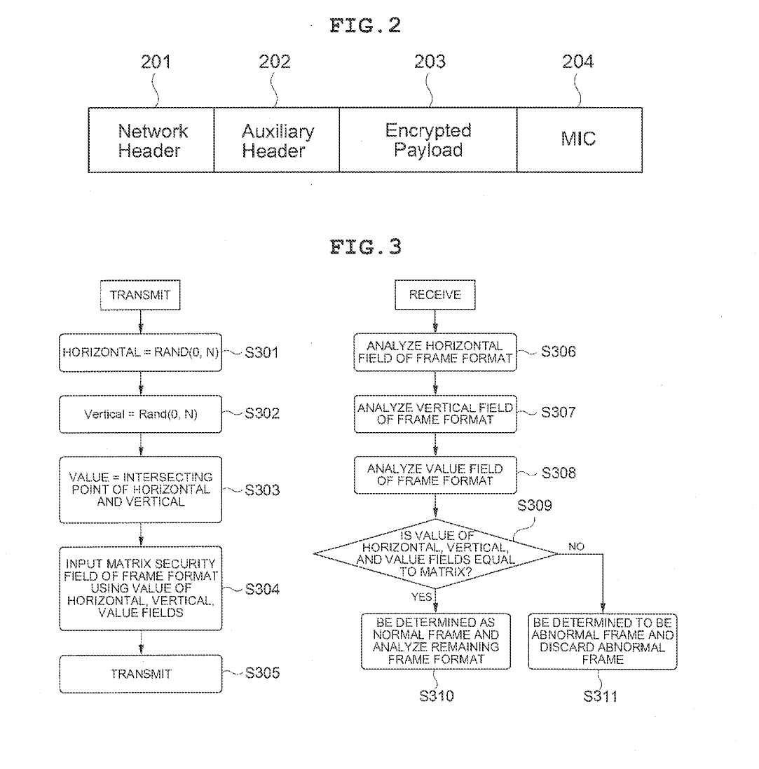

According to at least one embodiment, the sink (gateway) 120 and the tag 130 transmit and receive a signal using a wireless communication technology called Zigbee. In terms of wireless communication, the sink 120 and the tag 130 is easily installed but vulnerable to security. For example, there is a possibility that a malicious person analyzes wireless communication data, figure out patterns, and then manipulate the patterns to transmit the wireless communication data. Therefore, to cope with the security problem of communication, various encryption security methods are introduced. The encryption method is a method for encrypting and transmitting data at the time of transmission and decoding them again at the time of reception. A Zigbee protocol itself also includes a security mechanism using an encryption technology. FIG. 2 is a diagram illustrating an example of a Zigbee data frame structure of a general network level in which a security technology is adopted.

Referring to FIG. 2, a network header 201 includes information required for frame transmission in a network layer and an auxiliary header 202 includes a security control filed required to process an encryption technology. This designates a level of security applied to the corresponding frame and both of message encryption and integrity are processed at a time by a counter mode with cipher block chaining message (CCM) algorithm (one of the encryption algorithms). An encrypted payload 203 is stored with encrypted data. A many integrated core (MIC) 204 is used to protect the integrity of the header and the payload.

Meanwhile, the tag 130 uses a coin battery and therefore needs to be designed to simplify a computation operation if possible. When the tag 130 uses an encryption security method of the Zigbee protocol itself, a computation operation quantity is largely increased at the time of encryption and decoding and thus a used quantity of a battery is suddenly increased. Therefore, a simple security algorithm without a complicated computation operation is required.

In consideration of the above matters, at least one embodiment of the invention is to provide a wireless communication method in an ESL system capable of solving a security problem in wireless communication and reducing a computation operation quantity of a tag to reduce power consumption of a battery.

Hereinafter, the wireless communication method in the ESL system according to an embodiment of the invention based on the ESL system having the above configuration will be described.

FIG. 3 is a flow chart illustrating an execution process of a wireless communication method in an ESL system according to an embodiment of the invention.

Referring to FIG. 3, the wireless communication method in the ESL system according to an embodiment of the invention first selects any rows and columns in a matrix table to input each value of the selected rows and columns and values of intersecting points of the rows and the columns to each matrix security field of the data frame (S301 to S304). According to at least one embodiment, each value of the selected rows and columns is each input to a 4 bit field of the data frame and the values of the intersecting points of the rows and the columns is input to a 8 bit field of the data frame. In this case, the 4 bit field of the data frame to which each value of the rows and the columns is input and the 8 bit field of the data frame to which the values of the intersecting points of the rows and the columns are input is configured of the matrix security field of the data frame format.

Here, an embodiment will be described with reference to the input to the matrix security field of the data frame and the transmission and reception of the data packet to which a security value is input.

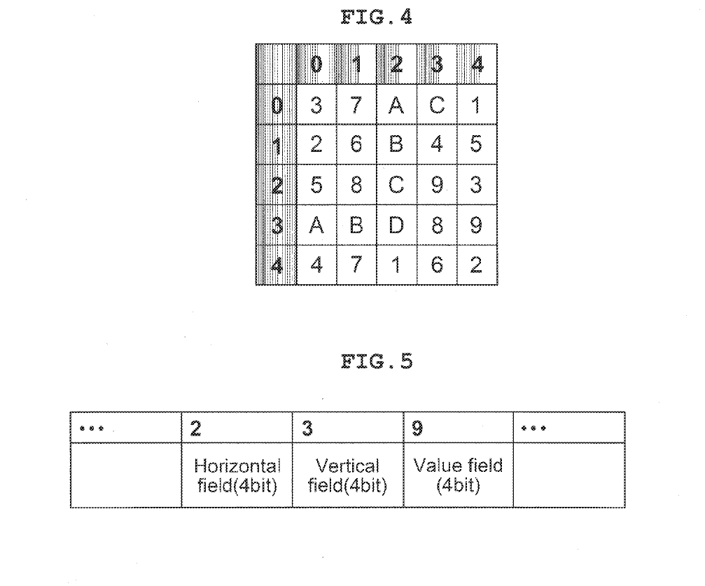

According to at least one embodiment, the method according to at least embodiment of the invention introduces the security algorithm of the matrix type as illustrated in FIG. 4. The embodiment of the invention illustrates a 5×5 matrix, but is only one example and therefore various matrix types such as 4×4, 6×6, and 8×8 matrices is applied.

According to at least one embodiment, the gateway 120 and the tag 130 share a matrix table of FIG. 4. Every time data are transferred therebetween, values are randomly selected from the matrix table and are transmitted. For example, in the matrix table of FIG. 4, an intersecting value of a horizontal second row and a vertical third column is “9”.

In this case, as illustrated in FIG. 5, “2” which is a value of the row is input to a 4 bit field (horizontal field) which is the matrix security field of the data frame format, “3” which is the value of the column is input to a 4 bit field (vertical field) which is the matrix security field, and then “9” which is the intersecting value is input to a 8 bit field (value field) which is the matrix security field, which are in turn transmitted. Next, at the receiving side, the intersecting points of the rows and the columns in the matrix table as illustrated in FIG. 4 are found with values of 2 and 3 which are the values of the rows and the columns. Further, when the found value is equal to “9”, the packet is determined to be a normal packet.

By the above description, when the input to the matrix security field of the data frame is completed, the frame (packet) is wirelessly transmitted from the tag 130 to the gateway 120 or from the gateway 120 to the tag 130 (S305).

Next, the gateway 120 or the tag 130 receives the transmitted frame (packet) and uses matrix values each written in the matrix security field to retrieve the values of the intersecting points in the matrix table (S306 to S308). Thus, the gateway 120 or the tag 130 each analyzes the horizontal field, the vertical field, and the value field of the received flame format and compares the analyzed result with the matrix table stored in the inside (memory) thereof.

Further, it is discriminated that the values of the retrieved intersecting points are equal to the values of the intersecting points written in the matrix security filed of the received frame (packet) (S309). Thus, it is discriminated that each value of the horizontal field, the vertical field, and the value field which are analyzed as described above is equal to the values written in the matrix table.

In the discrimination of S309, when the two values are equal to each other, the received frame (packet) is determined to be the normal frame (packet) and the remaining field of the frame is analyzed (S310).

Further, in the discrimination of S309, when the two values are not equal to each other, the received frame (packet) is determined to be an abnormal frame (packet) and discarded (S311).

As described above, the wireless communication method in the ESL system according to various embodiments of the invention apply the security algorithm of the matrix type to solve the security problem in the wireless communication and reduce the computation operation quantity of the tag to reduce the power consumption of the battery.

According to various embodiments of the invention, it is possible to solve the security problem in the wireless communication and reduce the computation operation quantity of the tag to reduce the power consumption of the battery, by applying the simple security algorithm of the matrix type.

Terms used herein are provided to explain embodiments, not limiting the invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the invention may suitably comprise, consist or consist essentially of the elements disclosed and may be practiced in the absence of an element not disclosed. According to at least one embodiment, it can be recognized by those skilled in the art that certain steps can be combined into a single step.

The terms and words used in the specification and claims should not be interpreted as being limited to typical meanings or dictionary definitions, but should be interpreted as having meanings and concepts relevant to the technical scope of the invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, it will be understood that unless a term such as ‘directly’ is not used in a connection, coupling, or disposition relationship between one component and another component, one component may be ‘directly connected to’, ‘directly coupled to’ or ‘directly disposed to’ another element or be connected to, coupled to, or disposed to another element, having the other element intervening therebetween.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the invention has been described in detail, it should be understood that various changes, substitutions, and alterations can be made hereupon without departing from the principle and scope of the invention. Accordingly, the scope of the invention should be determined by the following claims and their appropriate legal equivalents.

What is claimed is:

1. A wireless communication method in an ESL system, the wireless communication method comprising:
a) selecting any rows and columns in a matrix table to input each value of the selected rows and columns and values of intersecting points of the rows and the columns to matrix security fields of a data frame, respectively;
b) wirelessly transmitting the frame from a tag to a gateway or from the gateway to the tag;
c) receiving the transmitted frame by the gateway or the tag and using a matrix value written in the matrix security fields, respectively to retrieve the values of the intersecting points in the matrix table;
d) discriminating whether the values of the retrieved intersecting point are equal to the values of the intersecting points written in the matrix security field of the received frame; and
e) when two values are equal to each other in the discrimination, determining the received frame as a normal frame and analyzing the remaining field of the frame.

2. The wireless communication method according to claim 1, wherein the step d) comprises discriminating further comprises determining and discarding the received frame as an abnormal frame when the two values are not equal to each other.

3. The wireless communication method according to claim 1, wherein each value of columns and rows selected in the step a) is each input to a 4 bit field of the data frame and the values of the intersecting points of the rows and the columns are input to a 8 bit field of the data frame.

4. The wireless communication method according to claim 3, wherein the 4 bit field of the data frame to which each value of the rows and the columns is input and the 8 bit field of the data frame to which the values of the intersecting points of the rows and the columns are input are configured of the matrix security field of a data frame format.

5. The wireless communication method according to claim 1, wherein in the step c), the gateway or the tag analyzes a horizontal field, a vertical field, and a value field of a received frame format, respectively and compares the analyzed result with a matrix table stored in a memory thereof.
